(19) United States
(12) Patent Application Publication
(10) Pub. No.: US 2006/0151968 A1
(43) Pub. Date: Jul. 13, 2006

(54) Steering suspension having steering adjusted camber for McPherson and double linkage suspension

(76) Inventor: Matthew Kim, Walnut Creek, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/341,090

(22) Filed: Jan. 26, 2006

Related U.S. Application Data
(63) Continuation-in-part of application No. 10/864,557, filed on Jun. 8, 2004.
(60) Provisional application No. 60/477,473, filed on Jun. 9, 2003.

(51) Int. Cl. B60G 7/02

(52) U.S. Cl. 280/86.757

(57) ABSTRACT

A McPherson strut system and double wishbone suspension system is adapted to provide adjustable camber of the suspended wheel responsive to steering of the vehicle. The upper member of a McPherson strut or the upper link of a double wishbone is provided with a slide permitting horizontally supported freedom of movement with respect to the chassis. By providing a link through the slide to the kingpin, camber adjustment responsive to steering motion is attained for McPherson and double wishbone suspensions. The camber adjusting apparatus for steered wheels of a vehicle has a wheel support for each steered wheel that rotatably mounts the wheel and is pivotable about a generally horizontal axis that is transverse to an axis of rotation of the wheel. A steering mechanism pivotally moves the wheel support about a steering axis for steering the wheels, and the camber adjusting mechanism located either behind or in front of the wheel suspension tilts the wheel support relative to a vertical plane as a function of and in response to pivotal steering movements of the support structure about the horizontal axis.

### CROSS-REFERENCES TO RELATED APPLICATIONS

This Continuation-In-Part Application claims the benefit of Provisional Patent Application 60/477,473 filed Jun. 9, 2003 entitled STEERING WITH TRIPLE LINKAGE SUSPENSION HAVING STEERING ADJUSTED CAMBER; and Non-Provisional patent application Ser. No. 10/864,557 filed Jun. 8, 2004 entitled STEERING WITH TRIPLE LINKAGE SUSPENSION HAVING STEERING ADJUSTED CAMBER (the “Parent Application”).

### BACKGROUND OF THE INVENTION

This invention relates to steering of automobiles. Specifically, this invention relates to a mechanical steering linkage which cants steered wheels during a turn to provide for evenly distributed tire distribution during high speed turns, typically encountered by racing cars making turns. In this application, mechanical steering linkage for adapting linkage to McPherson suspension and double wishbone suspension is disclosed.

In four-wheel, steered vehicles, so-called double linkage or “wishbone” suspensions for the steered forward wheels of such vehicles are well known. In understanding the double linkage suspensions, conventional steering will first be described. Thereafter, the interaction of a double linkage on such conventional steering will be set forth.

In conventional steering, a wheel hub is mounted for rotation in a vertical plane about and normal to a horizontally disposed steering spindle. This steering spindle is in turn connected by a vertical kingpin to a steering knuckle. Rotation of the steering spindle and the steering knuckle on the vertical kingpin occurs through a steering linkage assembly. The steering linkage assembly includes a tie rod arm fixed to and rotating with the steering spindle and a tie rod actuated by the vehicle steering wheel. Movement of the tie rod causes rotation of the tie rod arm with rotation of the steering spindle about the vertical kingpin. As the steering spindle rotates, the generally vertical plane of wheel hub rotation turns to steer the vehicle.

The double linkage suspension of conventional steering is well known. Upper and lower arms (or links) are utilized to support the steering knuckle. The outer ends of such arms are typically pinned to the steering knuckle. The inner ends of such arms are attached to the vehicle. Thus, the steering knuckle can move upwardly and downwardly with respect to the vehicle body while being maintained in the generally vertical relationship relative to the vehicle. Preferably, at least one of the arms is connected by a suspension system to the vehicle. This suspension system supports the vehicle and expands and contracts to isolate and absorb shock transmitted to the steering knuckle through the wheel. Thus, shock at the wheel is prevented from reaching the vehicle by the shock absorbing suspension system.

Sometimes, such double arm suspension systems are characterized by the term “wishbone”. When the arms are viewed from above towards the ground over which the vehicle travels, the arms have a generally triangular shape. The apex end of such triangularly-shaped arms is attached to the steering knuckle. The base end of such triangularly-shaped arms is attached to the vehicle. This triangular shape imparts structural rigidity to the steering suspension. The upper and lower arms of “wishbone” suspensions in modern production cars have either triangular or linear forms, depending on the space available within the body of the car. This serves as the connection to the vehicle suspension system. Open-wheel racecars typically do not have such space restraints, and therefore both the upper and lower arms assume the traditional double “wishbone” configuration.

The upper and lower arms can vary in length between the steering knuckle and the vehicle. Where these arms are other than even in length, the vertical disposition of the steering knuckle and the vertical kingpin can change with up-and-down movement. Consequently, the steering spindle will vary from the horizontal. This variance from the horizontal imparts to the plane of wheel rotation the variance from the vertical. This variance of the plane of wheel rotation from the vertical is known as “camber”.

It is important to note that in such systems variance of the camber is solely a function of the change of position of the steering knuckle relative to the vehicle. This change of position of the steering knuckle relative to the vehicle is in turn controlled by the suspension between the arms and the vehicle. It is especially important to note for the purposes of this disclosure that this prior art change of camber is in no way responsive to this steering of the vehicle.

In the usual case, when the vehicle is steered and in the absence of dynamic forces on the arms and the suspension, the plane of rotation of the wheel remains vertical. No camber is imparted to the steered wheel. Thus, for four-wheel vehicles, the steered wheels only change in camber responsive to changing weight dynamics on the steered wheels.

The camber of a conventionally steered four-wheel vehicle is to be contrasted with a two-wheel vehicle, such as a motorcycle. As is well-known, two-wheel vehicles “lean into” their turns. Thus, the camber of the wheels changes responsive to steering (and speed) of such vehicles. In the usual case, this change of camber is highly advantageous. Specifically, the tires of such two-wheel vehicles are designed with curvilinear cross-sections so that this changing camber produces an optimum footprint with respect to the road to enable a maximum grip relative to the road.

The function of this grip can be easily understood.

When a motorcycle travels on a straight-line path, only the vertical weight of the motorcycle on the steered and driven motorcycle wheels reacts through the tires to the motorcycle. The motorcycle wheels are conventionally, vertically loaded. When a motorcycle turns on a curved path, the vertical weight of the motorcycle on the steered and driven motorcycle wheel has added the dynamic forces generated when turning the motorcycle. Simply stated, when a motorcycle turns, centrifugal force must be overcome in turning. Thus, the wheels lean into the turn and react both to the vertical weight of the motorcycle and the centrifugal force necessary to turn the motorcycle.

I have discovered that it would be highly desirable to vary the camber of the steered front and rear wheels of a four-wheel vehicle in a manner analogous to the wheels of a steered motorcycle.

The Parent Application discloses a double linkage steering system for a four-wheel vehicle which changes the linkage length relative to the vehicle responsive to steering. Specifically, upon the wheel turning toward the inside of the vehicle, the tie rod of the steering system extends to turn the wheel plane of rotation toward the inside of the vehicle. At the same time, the steering pulls the upper linkage toward the vehicle causing this steering knuckle to tilt toward the vehicle. The horizontal disposition of the wheel spindle changes with the steering knuckle tilt. Camber angles of the steered wheels are altered with the plane of wheel rotation, tilting at the top toward or away from the vehicle. This same camber angle can be imparted to rear non-steered wheels. As a result, wheel camber responsive to wheel steering analogous to that of a two-wheel vehicle occurs.

The steering suspension disclosed in the Parent Application is not applicable to McPherson suspensions in which a chassis-affixed strut supports the upper end of the kingpin. Motion of the top of the kingpin towards and away from the chassis is not possible.

Further, the Parent Application applicable to the double wishbone suspension did not provide a chassis-connected support point that would accept the loading required by a vehicle under the dynamics of high speed turns, such as those encountered in racing.

### SUMMARY OF THE INVENTION

A McPherson strut system and double wishbone suspension system is adapted to provide adjustable camber of the suspended wheel that is responsive to steering of the vehicle. The upper member of a McPherson strut or the upper arm of a double wishbone has a slide permitting horizontally supported freedom of movement with respect to the chassis. By providing a link via the slide to the axis of steering knuckle turning, camber adjustment responsive to steering motion is attained for McPherson and double wishbone suspensions.

In a vehicle steering system having a McPherson suspension, the wheel to be steered is mounted on a steering spindle so that the wheel can be steered for rotation about a generally vertical line. A steering knuckle is attached to the steering spindle. A strut assembly has an upper end attached to the vehicle chassis and a lower end supporting the steering knuckle. A lower arm of the suspension is pivoted at a first end to the steering knuckle and pivoted at a second end to the vehicle. A steering linkage assembly includes a tie rod for a movement with the vehicle steering system and a tie rod arm for rotating the steering knuckle with the steering spindle about the strut assembly. Movement of the tie rod by the vehicle steering system correspondingly moves the steering knuckle in rotation about the strut assembly to steer the vehicle. The vehicle steering system includes a slide on the upper strut support which enables movement of the strut assembly to change the camber of the strut assembly. A linkage between the vehicle steering system through the slide changes the camber of the strut assembly relative to the vehicle responsive to vehicle steering so that the camber of a wheel is changed responsive to steering.

Another aspect of the invention relates to vehicle steering systems having a double wishbone suspension where a wheel to be steered is conventionally mounted to a spindle projecting from a steering knuckle for rotation about a generally vertical plane. An upper link is attached to the upper end of the steering knuckle and to a point on the vehicle chassis. A lower link is pivoted at a first end to the steering knuckle and at a second end on the vehicle chassis. The steering knuckle is pivotal about a steering axis. A steerage linkage assembly includes the tie rod for a movement with the steering system and a tie rod arm for rotating with the steering knuckle about the steering axis. This enables movement of the tie rod by the vehicle steering system and correspondingly moves the steering knuckle in rotation to steer the vehicle. A strut assembly is supported on the vehicle chassis at an upper end and pivoted to the steering knuckle at the lower end to provide the major support link to the chassis. A chassis-supported slide on the upper linkage permits movement of the linkage to change the camber of the axis about which steering knuckle rotates. A linkage between the vehicle steering system through the slide changes the camber of the steering axis relative to the vehicle responsive to vehicle steering so that the camber of a wheel is changed responsive to steering.

The foregoing results in suspensions which improve car control during high speed turns and provides superior turning, braking and acceleration by maximizing the road-contacting patch of a tire.

### BRIEF DESCRIPTION OF THE DRAWINGS

FIG. 1A is a prior art front elevation view of a conventional double linkage vehicle suspension system;

FIG. 1B is a prior art plan view of the conventional double linkage vehicle suspension system shown in FIG. 1A;

FIG. 2A is a rear elevation of one wheel of the steering system of this invention illustrating the steering tie rod and upper linkage imparting vertical camber to a spindle-mounted hub on the steering system;

FIG. 2B is a rear elevation of one wheel of the steering system of this invention according to FIG. 2A illustrating the suspension system experiencing a vertical load, such as a bump or a dip in the road, with no steering input or lateral load imposed and no change in camber allowing the wheel to remain normal to the road, maximizing the tire's contact patch for this condition;

FIG. 2C is a rear elevation of the outboard, laden wheel of the steering system of this invention according to FIG. 2B illustrating the suspension system experiencing a vertical and lateral load such as a change in direction with steering tie rod turning the spindle-mounted hub by extending away from the vehicle and pulling the upper steering linkage in towards the vehicle to both increase the turn and increase the camber angle, leaning the bottom of this steered wheel to the outside of the turn;

FIG. 3A is a front elevation of one wheel of the steering system of this invention illustrating the steering tie rod and upper linkage imparting vertical camber to a spindle-mounted hub on the steering system;

FIG. 3B is a front elevation of one wheel of the steering system of this invention according to FIG. 3A illustrating the suspension system experiencing a vertical load, such as a bump or a dip in the road, with no steering input or lateral load imposed in this condition, and no change in camber, which allows the wheels to remain normal to the road, maximizing the tire's contact patch for this condition;

FIG. 3C is a front elevation of the outboard, laden wheel of the steering system of this invention according to FIG. 3B illustrating the suspension system experiencing a vertical and lateral load such as a change in direction with steering tie rod turning the spindle-mounted hub by extending away from the vehicle and pulling the upper steering linkage in towards the vehicle to both increase the turn and increase the camber angle, leaning the bottom of this steered wheel to the outside of the turn;

FIG. 3D is a perspective front elevation similar to FIG. 3C changing the angle of view of the wheel club to illustrate steered deflection and changed camber;

FIG. 3E is a rear elevation of the inboard, unladen wheel of the steering system of this invention according to FIG. 3B illustrating the suspension system experiencing a vertical and lateral load such as a change in direction with the steering tie rod turning the spindle-mounted hub by pulling it towards the vehicle and extending the upper steering linkage away from the vehicle to both increase the turn and increase the camber angle, leaning the bottom of this steered wheel to the outside of the turn;

FIG. 4 is a plan view of the invention shown in FIGS. 2A-2D and 3A-3E;

FIG. 5A is an elevation of the front left and right suspensions according to FIG. 3C and FIG. 3E illustrating the suspension system experiencing a change in direction to the right with the suspension system leaning the tires into the corner, much like a motorcycle;

FIG. 5B is an elevation of the rear elevation of the rear left and right suspensions illustrating the suspension system experiencing a change in direction to the right with the suspension system leaning the tires into the corner, much like a motorcycle;

FIG. 5C is a rear view of the front and rear suspensions illustrating the suspension system experiencing a change in direction to the right with the front and rear suspension systems working in tandem to lean the tires into the corner, much like a motorcycle;

FIG. 6A is a prior art front elevation diagram of a conventional double linkage vehicle suspension system and plan views of the tires' contact patches, showing the vehicle at rest and the contact patches displaying the maximum surface area;

FIG. 6B is a prior art front elevation diagram of a conventional double linkage vehicle suspension system and plan views of the tires' contact patches according to FIG. 6A showing the vehicle under vertical loading, and the contact patches displaying a compromised tire contact patch due to the negative camber built into the prior art design;

FIG. 6C is a prior art front elevation diagram of a conventional double linkage vehicle suspension system and plan views of the tires' contact patches according to FIG. 6A showing the vehicle under vertical loading and lateral loading, and the laden wheel displaying a maximum contact patch due to the negative camber and the bending and distortion of the linkages and tire caused by lateral forces, while the unladen wheel is displaying a compromised tire contact patch due to the negative camber built into the prior art design;

FIG. 6D is a front elevation suspension diagram of this invention and plan views of the tires' contact patches, showing the vehicle at rest and the contact patches displaying the maximum surface area;

FIG. 6E is a front elevation suspension diagram of this invention and plan views of the tires' contact patches according to FIG. 6D showing the vehicle under vertical loading, and the contact patches displaying no change in camber, thus providing the maximum contact patch;

FIG. 6F is a front elevation suspension diagram of this invention and plan views of the tires' contact patches according to FIG. 6D showing the vehicle under vertical loading and lateral loading, and both wheels displaying maximum contact patches due to the cambers favorably generated to counteract any bending and distortion of the linkages and tire caused by lateral forces;

FIG. 7A is a front elevation of a McPherson suspension improved with a horizontal slide on the strut for permitting wheel camber change responsive to steering;

FIG. 7B is a top plan view of the McPherson suspension of FIG. 7A illustrating the construction of the slide that is part of the camber adjustment system;

FIG. 8 is a front elevation of a double wishbone suspension improved with a horizontal slide supported from the chassis and affixed to the upper strut for permitting wheel camber change responsive to linkage extension during steering;

FIG. 9A is a plan view of the embodiment of the present invention suitable for use on vehicles on which the steering linkage is in front of the vehicle, the top of the figure being the front of the vehicle;

FIG. 9B is a front elevation of the embodiment shown in FIG. 9A;

FIG. 9C is a front elevation similar to FIG. 9B but shows the wheel turning to the right relative to the vehicle; and

FIG. 9D is a front elevation similar to FIG. 9C but shows the wheel turning to the left.

### DETAILED DESCRIPTION OF THE INVENTION

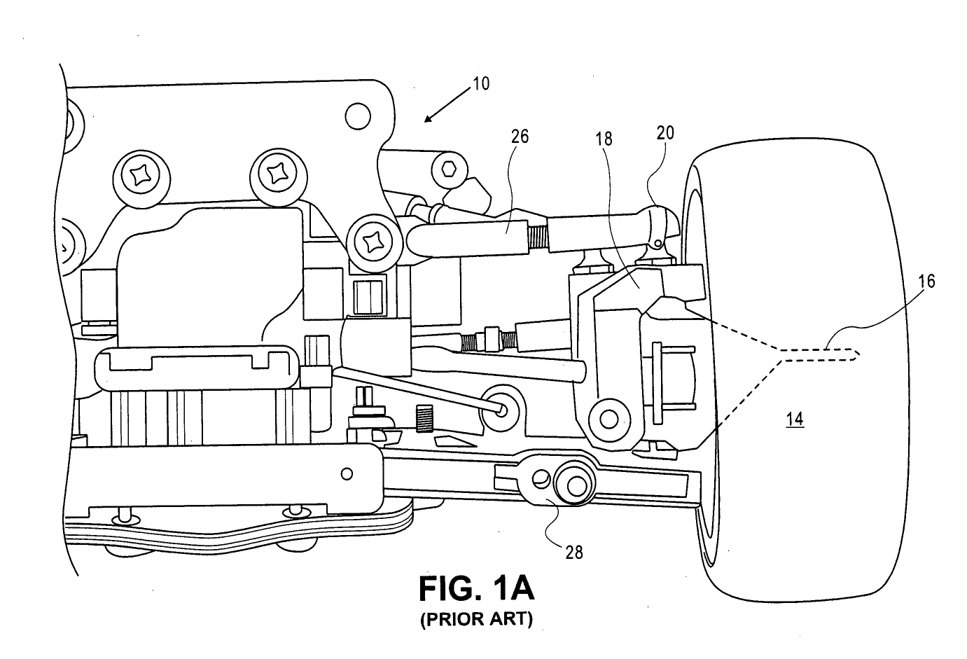

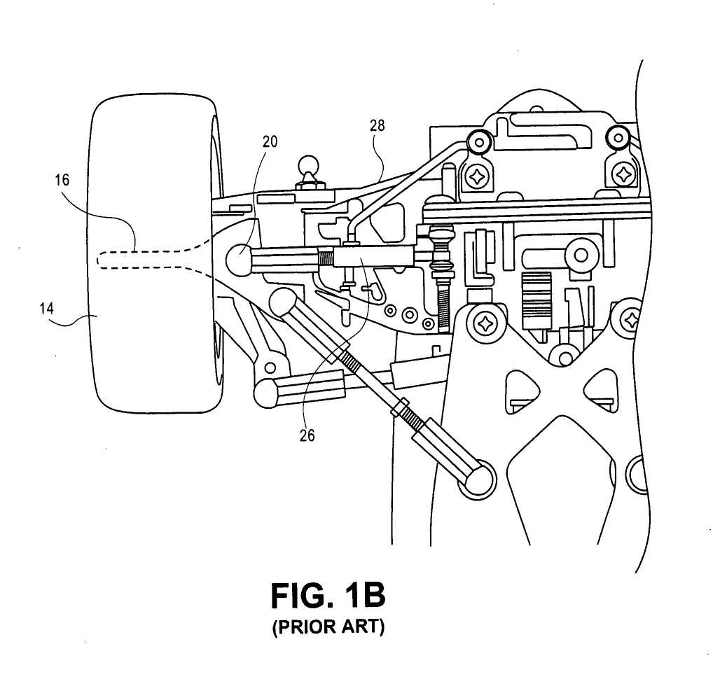

Referring to prior art FIGS. 1A and 1B, wheel 14 is shown rotating about spindle 16 at a hub 15. Spindle 16 extends from steering knuckle 18 which is pivotable about a kingpin 20 for steering the vehicle. Spindle 16 has upper arm 26 linked to lower arm 28. Tie rod 32 is responsive to the vehicle's steering system and moves towards and away from vehicle 10. Since spindle 16 is substantially horizontal, wheel 14 rotates in a generally vertical plane.

Referring to FIG. 1A, upper arm 26 and lower arm 28 can be seen extending between steering knuckle 18 and vehicle 10. The arms 26, 28 have essentially the same length. As is shown in FIG. 1B, lower arm 28 is triangular in plan with the apex end of the arm pinned to the lower portion of the steering knuckle 18. Suspension 30 interconnects lower arm 28 and vehicle 10. It provides for the support of this steered wheel 14 relative to the vehicle 10.

In the system of FIGS. 1A and 1B, the camber of wheel 14 is essentially constant with up-and-down movement of steering knuckle 18. That is to say, the camber can only be changed substantially by changing the lengths of the upper arm 26 and lower arm 28 with respect to one another. Further, camber will not change in response to the steering of vehicle 10.

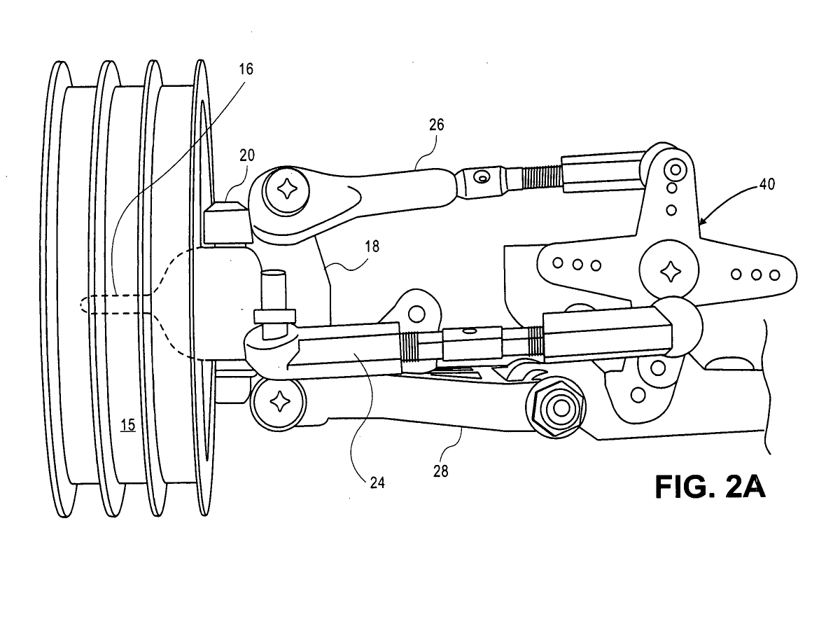

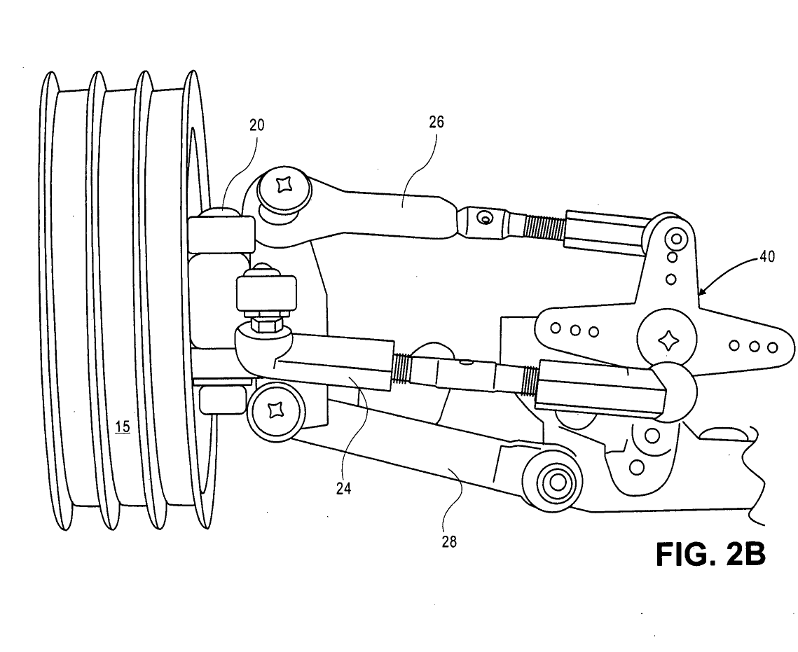

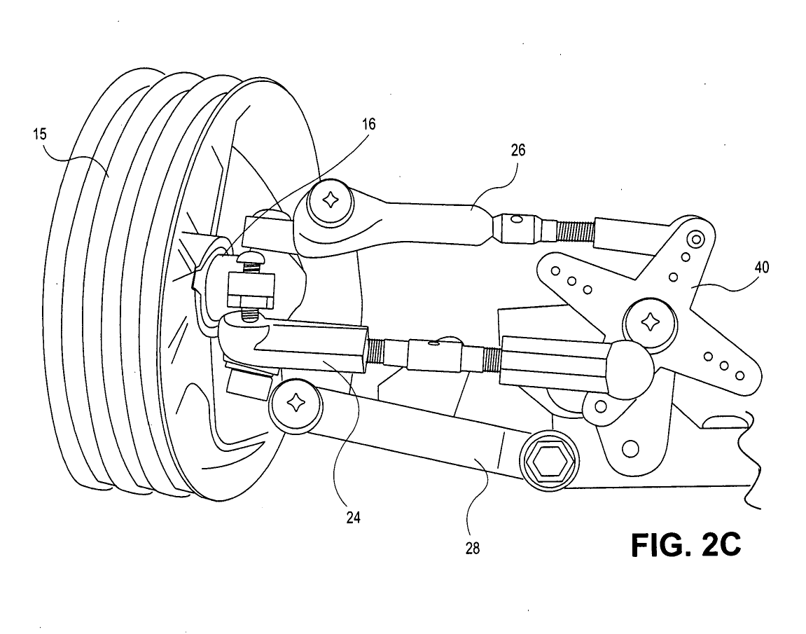

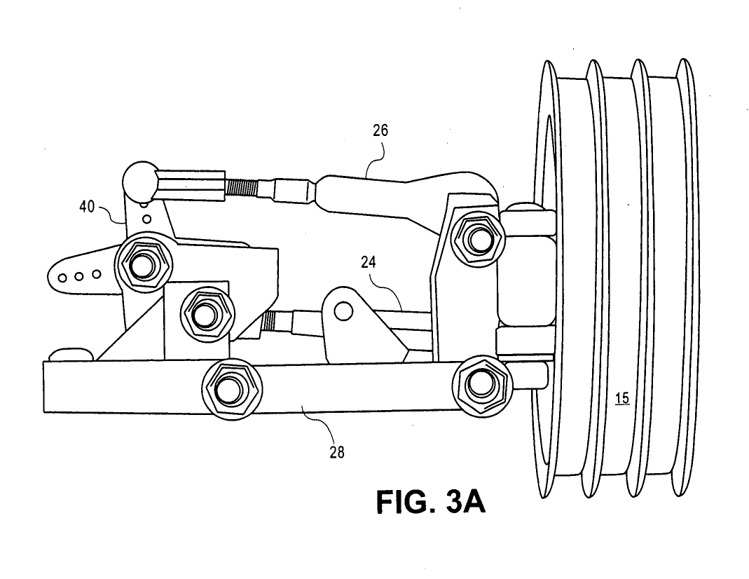

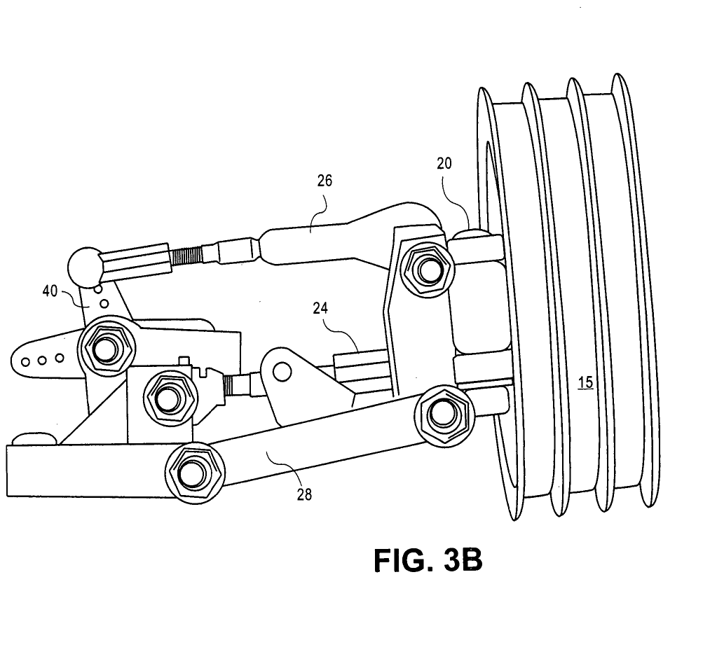

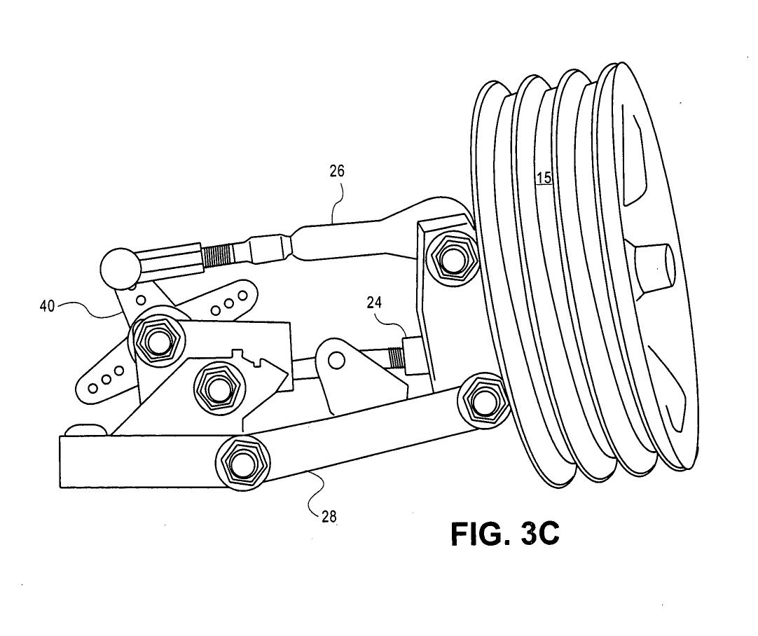

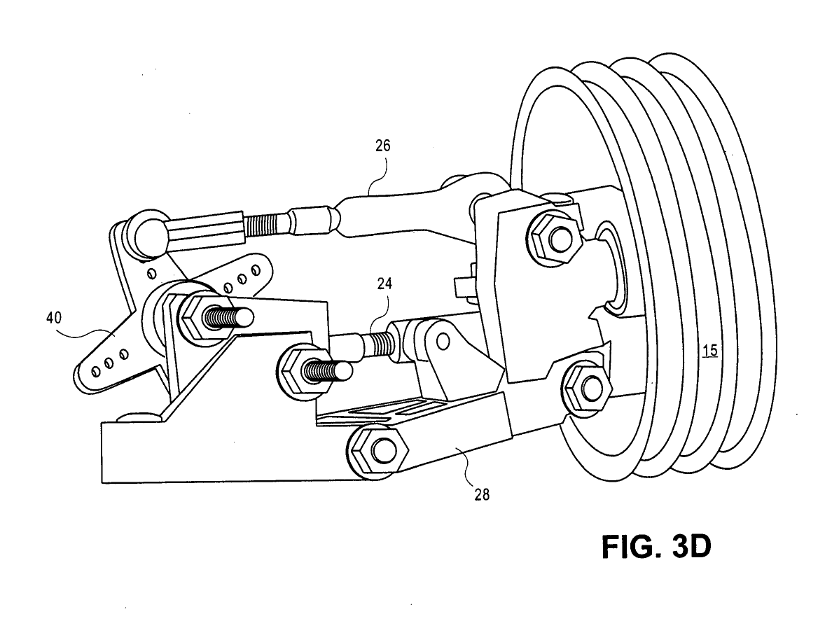

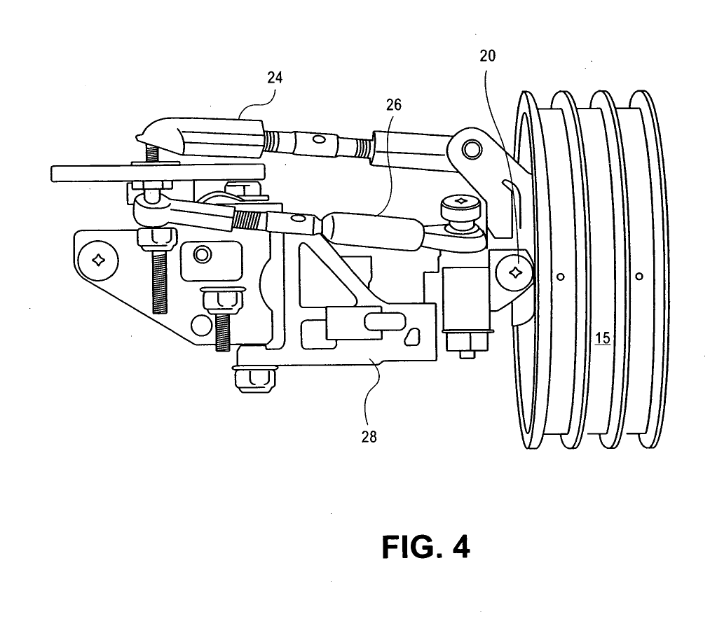

Addressing the present invention and referring to FIGS. 2A and 3A, wheel 14 has been removed, exposing hub 15 on spindle 16, which is shown in phantom. Steering mechanism 40 of vehicle 10 is shown in the form of star wheel 40. Star wheel 40 has two linkages attached thereto. A tie rod 24 is connected to the lower portion of the star wheel for turning spindle 15 conventionally about vertical kingpin 20, and conventional steering of hub 15 (and spindle 16) occurs. Further, an upper link 26 has its ends attached to an upper portion of star wheel 40 and to steering knuckle 18. Upon pivotal movement of star wheel 40 in the clockwise (FIG. 2A front elevation) direction, tie rod 24 is moved to the left as seen in FIG. 2A and hub 15 will turn towards the vehicle 10. At the same time, upper link 26 is pulled toward vehicle 10 and pulls knuckle 18 with it, which leans the top portion of the knuckle towards the vehicle (not shown in this view). This causes the bottom of hub 15 to move away from vehicle 10. The result is a change in the camber of hub 15. These movements can be observed in FIGS. 2C, 3C and 3D.

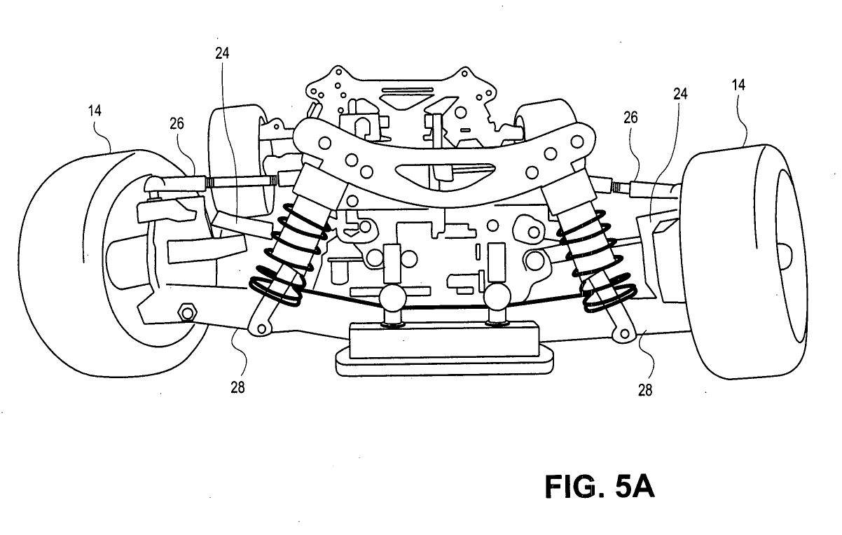

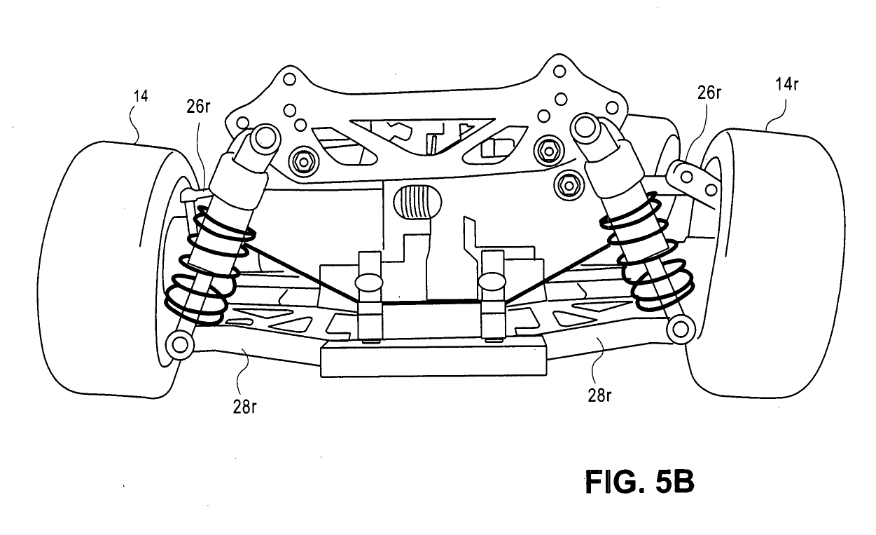

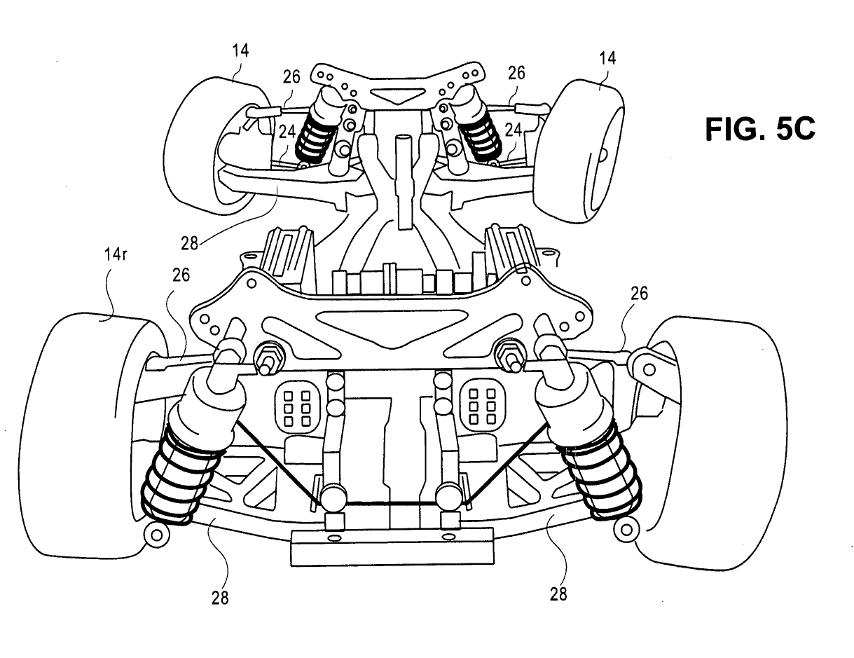

Wide variations in the proportional movement and direction of the respective linkages can occur. For example, the length of the lower link 28 can be very responsive to the movement of tie rod 24. Further, the lever arm of star wheel 40 for both tie rod 24 and upper link 26 can be altered to virtually any desired ratio to vary the proportional relationship between the steering and camber adjusting movements. Additionally, as shown here, variation of the camber of the steered wheel is responsive to movement of the steering mechanism. This same mechanism for variation of camber can also be applied to the driven rear wheels of a four-wheel vehicle. This is illustrated schematically in FIGS. 5A, 5B and 5C, it being noted that although changes in camber are shown, a linkage between the steered wheels and the rear, non-steered wheels is omitted. The reader will understand that virtually any linkage will do. For example, by placing a star wheel 40 adjacent the non-steered wheels and linking to the front star wheel 40, camber can be imparted to the rear steered wheels. Similarly, servos and the like can impart the desired camber. As can be seen in FIGS. 5A, 5B and 5C, the respective rear wheels are labeled 14r, and upper link 26r and lower link 28r, in the drawings.

Further, the steering mechanism here shown in the form of star wheel 40 is exemplary only. All kinds of steering mechanisms can respond to the linkage here shown. For example, rack and pinion steering could as well be used. These and other variations of this invention can occur.

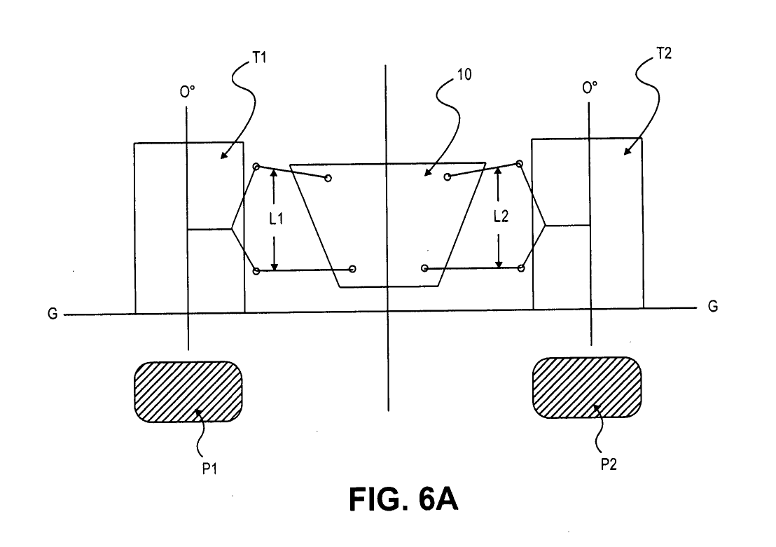

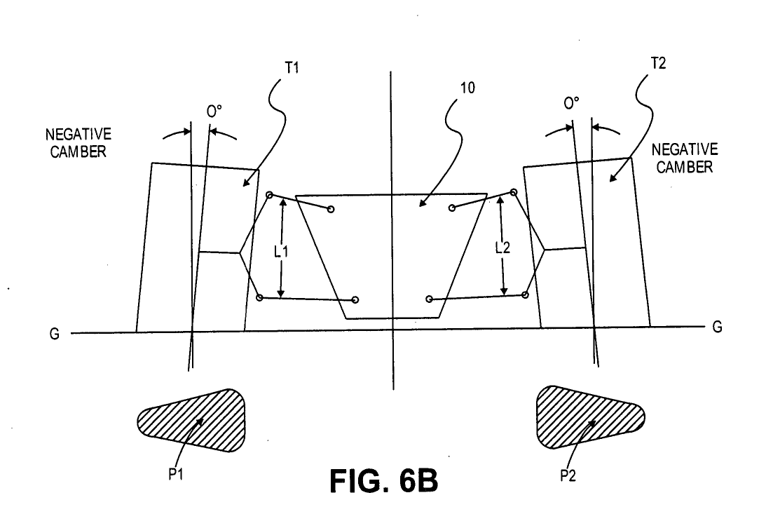

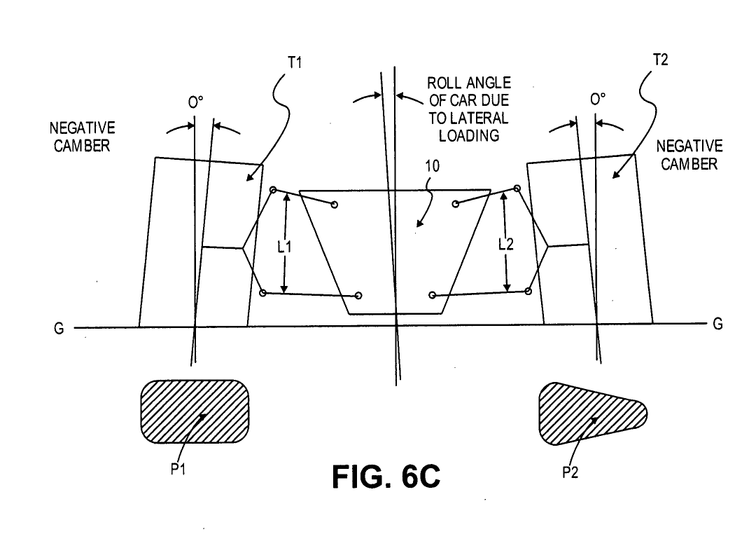

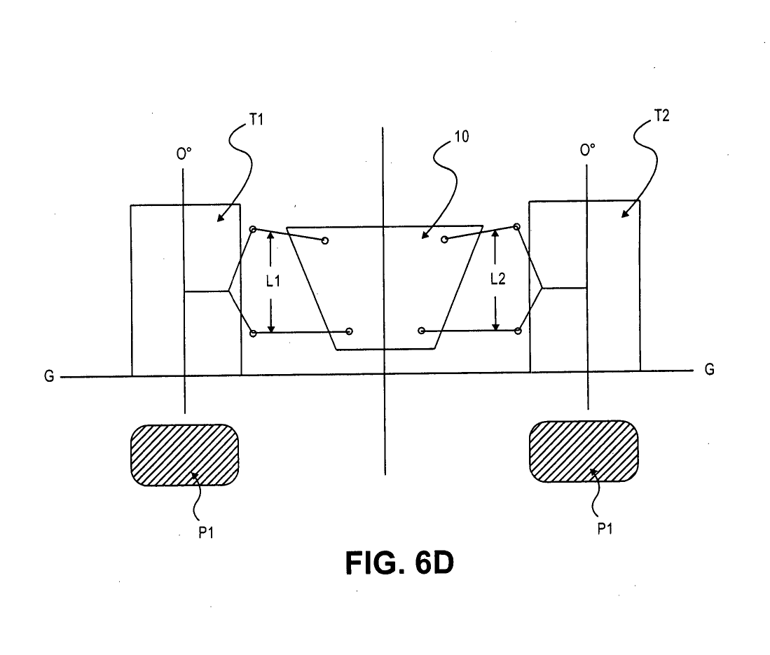

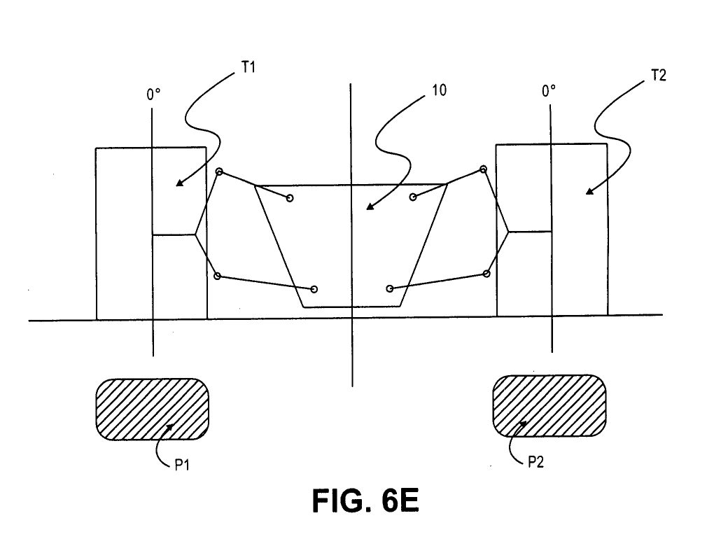

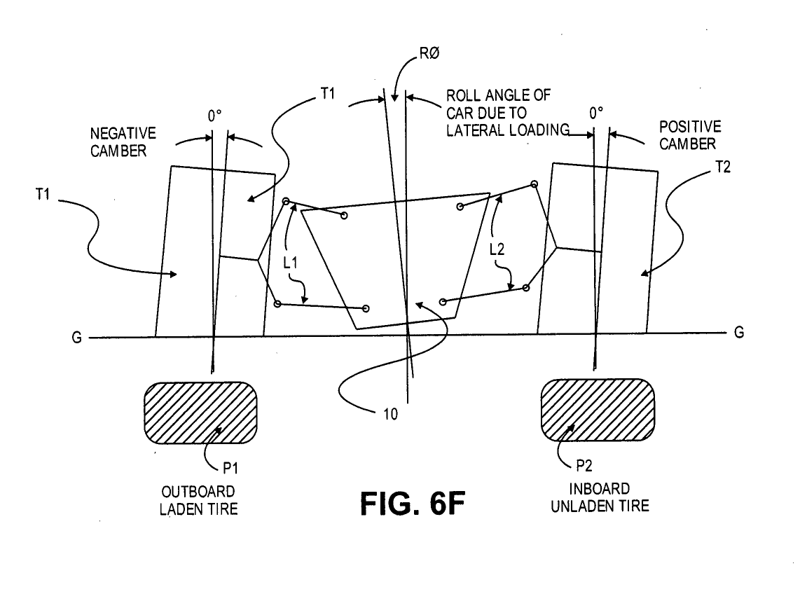

Referring to the prior art FIG. 6A, wheel assembly T1 is shown to be connected to vehicle 10 by linkage assembly L1. Likewise, wheel assembly T2 is shown to be connected to vehicle 10 by linkage assembly L2. Vehicle 10 is shown to be at rest or traveling at a constant velocity with no vertical or lateral loading. Contact patches P1 and P2 are the surface areas of tires T1 and T2 respectively, making contact with road surface G as seen from below, as if road surface G were transparent. T1 and T2 are shown to be normal to the road surface, that is, zero camber, and contact patches P1 and P2 are shown to have the maximum surface area making contact to road surface G.

Referring to the prior art FIG. 6B, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a vertical load. Contact patches P1 and P2 are the surface areas of tires T1 and T2 respectively, making contact with road surface G as seen from below, as if road surface G were transparent. T1 and T2 are shown to be imparting negative camber, consequently altering contact patches P1 and P2 to triangular-shaped surface areas making contact to road surface G, reducing the total surface area and thus providing less grip.

Referring to the prior art FIG. 6C, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a lateral load to the left. Contact patches P1 and P2 are the surface areas of tires T1 and T2 respectively, making contact with road surface G as seen from below, as if road surface G were transparent. Tire T1 is laterally loaded and is shown to be imparting negative camber, and because of the distortions of tire T1's cross-section and bending of linkage L1 caused by the lateral load and the subsequent rolling of the vehicle 10 by angle R0, contact patch P1 has a rectangular-shaped surface area making contact to road surface G, maximizing the grip for tire assembly T1. Tire T2 is unloaded and is shown to be imparting negative camber, altering contact patch P2 to a triangular-shaped surface area making contact to road surface G, reducing the maximum grip for tire assembly T2.

Referring to FIG. 6D of this invention, wheel assembly T1 is shown to be connected to vehicle 10 by linkage assembly L1. Likewise, wheel assembly T2 is shown to be connected to vehicle 10 by linkage assembly L2. Vehicle 10 is shown to be at rest or traveling at a constant velocity with no vertical or lateral loading. Contact patches P1 and P2 are the surface areas of tires T1 and T2 respectively, making contact with road surface G as seen from below, as if road surface G were transparent. T1 and T2 are shown to be normal to the road surface, that is, zero camber, and contact patches P1 and P2 are shown to have the maximum surface area making contact to road surface G.

Referring to FIG. 6E of this invention, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a vertical load. Contact patches P1 and P2 are the surface areas of tires T1 and T2 respectively, making contact with road surface G as seen from below, as if road surface G were transparent. T1 and T2 are shown to be normal to the road surface, that is, zero camber, and therefore contact patches P1 and P2 are unaffected and are shown to have the maximum surface area making contact to road surface G, providing the maximum possible grip.

Referring to FIG. 6F of this invention, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a lateral load to the left. Contact patches P1 and P2 are the surface areas of tires T1 and T2 respectively, making contact with road surface G as seen from below, as if road surface G were transparent. Tire T1 is laterally loaded and is shown to be imparting negative camber, and because of the distortions of tire T1's cross-section and bending of linkage L1 caused by the lateral load and the subsequent rolling of the vehicle 10 by angle R0, consequently alters contact patch P1 to a rectangular-shaped surface area making contact to road surface G, maximizing the grip for tire assembly T1. T2 is unloaded and is shown to be imparting positive camber, and because of the distortions of tire T2's cross-section and bending of linkage L2 caused by the lateral load and the subsequent rolling of the vehicle 10 by angle R0, consequently alters contact patch P1 to a rectangular-shaped surface area making contact to road surface G, maximizing the grip for tire assembly T2.

The change of camber of the wheels effectively changes the stability of a car to which this system is attached. When the tire is standing perpendicular or normal to the road surface, it has 0° of camber. This is shown in FIG. 6A. When the top of the tire is tilted in towards the car, it is said to have negative camber. This is shown in FIG. 6B. When the top of the tire tilts away from the center of the car, it has positive camber. This is shown on T2 of FIG. 6F. When the tire experiences lateral loading, the tire's coefficient of friction, or CF, varies with the change in camber, because of the cross-sectional distortion it experiences. See FIG. 6F. For the outboard loaded or laden tire, the CF increases from 0° camber to negative camber, and decreases from zero to positive camber. When the tire is subjected to lateral loading with 0° camber, the contact patch distorts from the optimum surface area because of the deflection and bending of the suspension components and the distortion of the tire's cross-section itself. Thus creating negative camber corrects the contact patch's distortion, and restores the patch to optimum surface area, only on the laterally loaded tire. This is the reason for the increase in the CF with negative camber. Note this change in the CF relative to camber only applies to lateral loading and not vertical loading conditions. An optimum operation of the contact patch is shown in FIG. 6F.

On vertical loading conditions, the tires must remain normal to the road surface, and any degree of camber is unfavorable, as it reduces the contact patch of the tires, thus reducing the grip capabilities of the tire. Specifically, each tire—either steered or non-steered—has a “contact patch” relative to the road. The contact patch is that portion of the tire that makes contact with the road. Moreover, most racing tires have a rectilinear cross-section at their periphery and point of contact to the road. Accordingly, and with a tire of rectilinear section, even a slight change of camber of the tire will shift the contact patch to the side of the tire and away from the center of the tire. The present invention's ability to favorably change the camber angles depending on the tires' loading condition maximizes the amount of grip the tires can generate. Improved steering, stability and, most important, maximum grip will result.

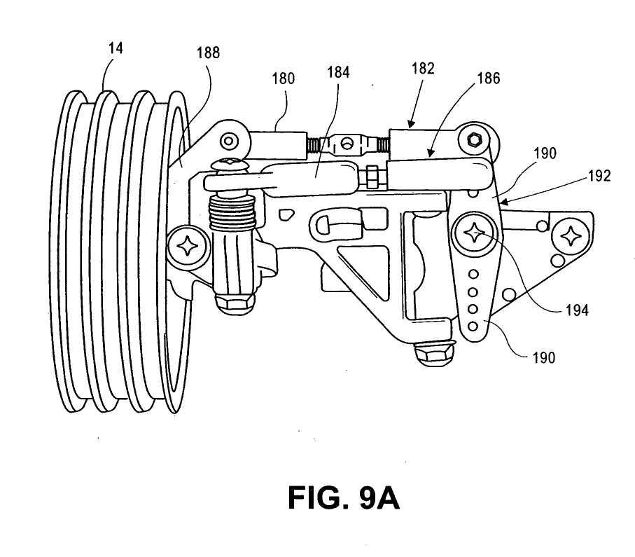

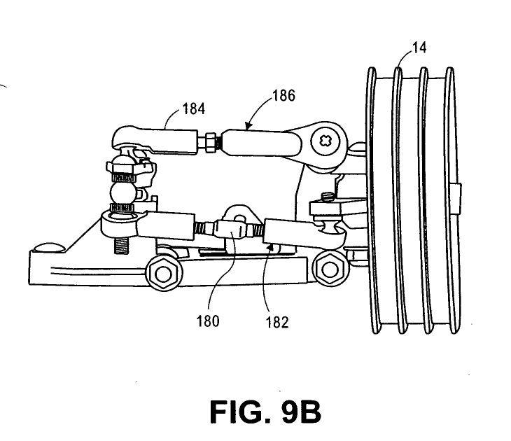

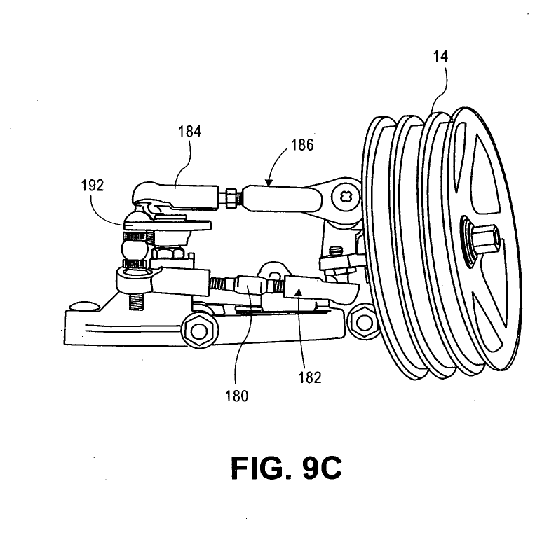

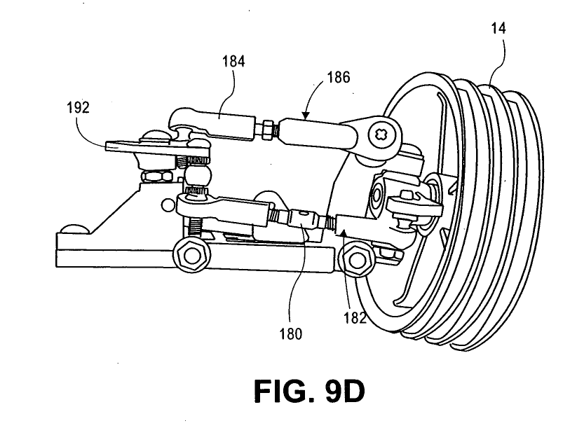

The combined steering/camber adjustment system described above is particularly suitable for cars on which the steering linkage is aft (as viewed in the travel direction of the vehicle) of the wheel suspension. It makes use of space available in front of the suspension for placing the camber adjustment mechanism. When the steering linkage is in front of the wheel suspension and axle or spindle about which the wheel rotates, the embodiments of the invention shown and described in connection with FIGS. 9A-9D are particularly suitable.

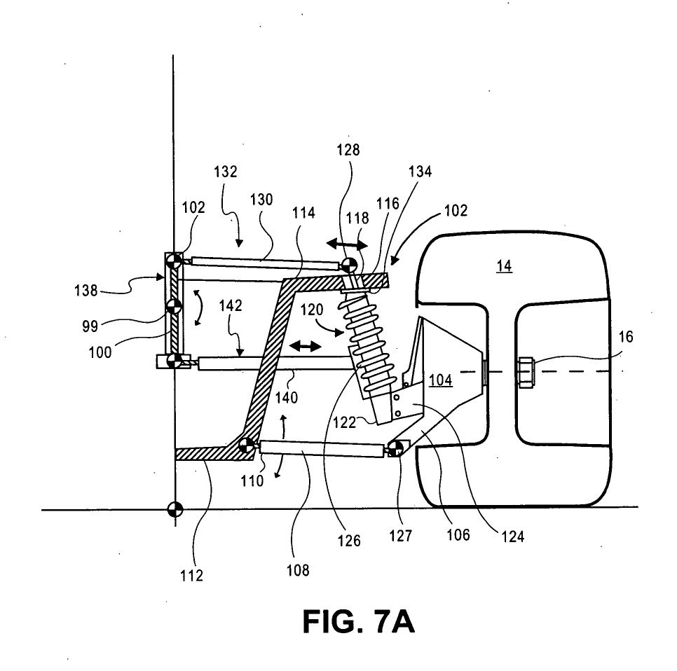

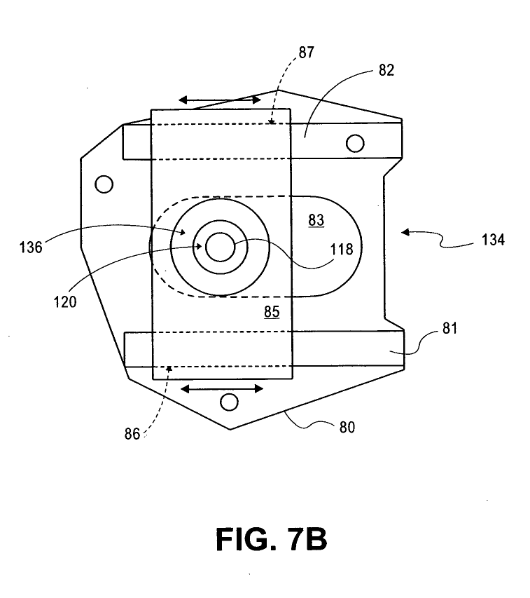

FIG. 7A illustrates a steered wheel 14 with a McPherson suspension 102. The wheel is mounted on a spindle 16 carried by a knuckle 104 with a lower extension 106 that is pivotally connected to a lower arm 108 which generally extends inwardly (towards the vehicle) and has an inner end 110 that is pivotally connected to a chassis 112 of the vehicle. The chassis includes a support wing 114 that is disposed some distance above the axis of wheel 14 and includes an aperture 116 through which a plunger 118 of a strut 120 (that includes a shock absorber) extends. A lower end 122 of the strut is conventionally fixed to knuckle 104 via a bracket 124 or the like. A conventional coil spring 126 surrounds the strut, and its ends are suitably supported by chassis wing 114 and knuckle bracket 124.

A head 128 of strut plunger 118 is located above the upper surface of chassis wing 114 and is pivotally connected to a camber adjustment link 130 of a camber adjusting system 132 constructed in accordance with the present invention. A linear slide bearing 134, shown in more detail in FIG. 7B, includes a mounting plate 80 that is rigidly secured, e.g. bolted, to the chassis wing so that an elongated slot 83 overlies aperture 116 in the chassis wing. A slide plate 85 of the bearing is movable along elongated tracks, such as grooves, 81, 82 in the mounting plate, and linear bearing units 86, 87 are interposed between the mounting and slide plates so that the latter can linearly move relative to the former in a direction parallel to slot 83. Slide plate 85 includes a tubular section 136 through which plunger 118 of strut assembly 120 extends past plates 80, 83 and aperture 116 in chassis wing 114. A linear bearing suitable for use with the present invention can be obtained from HIWIN Corp. of Mount Prospect, Ill. 60056 (LG Series).

Linear slide bearing 134 is secured, e.g. bolted, to chassis wing 114, and tracks 81, 82 of the mounting plate are oriented perpendicular to the horizontal camber pivot or tilt axis 127 between lower extension 106 of knuckle 104 and lower arm 108 so that, by moving strut head 128 to the left or the right, as indicated by the arrow in FIG. 7A, the wheel 14 is tilted about the camber pivot axis to thereby adjust the camber of the wheel positively or negatively, depending on the direction of movement.

To induce such pivotal motions of the knuckle and change the camber, the inward end of link 130 is pivotally connected to an actuator 138 that is used for steering wheel 14, as is further described below. Actuator 138 pivotally moves about a pivot point 99 and includes arms 100 that extend in both directions from pivot point 99. One of the arms is pivotally connected to link 130.

The other arm 100 is pivotally connected to a tie rod 140 that is part of a steering linkage 142 for the wheel. The other end of the tie rod is conventionally connected to knuckle 104 so that inboard or outboard movement of the tie rod, as indicated by the arrows immediately above it, causes wheel 14 to turn in one direction or the other.

In operation, turning of steering actuator 138, for example in a clockwise direction, pushes camber adjustment link 130 in an outboard direction (towards wheel 14) while it pulls steering linkage 142 in an inboard direction. This results in turning wheel 14 about a vertical turning axis (not shown in FIG. 7A) while it tilts wheel 14 about tilt axis 127 and gives the wheel the desired camber. Moreover, the greater the degree of steering, i.e. the more the wheel is turned, the greater is the camber because the camber is established as a function of the degree of turning since actuator 138 proportionally moves link 130 of the camber adjusting system 132 and tie rod 140 of the steering linkage 142. As actuator 138 is turned, camber adjusting link 130 linearly moves the top of strut 120 as guided by linear slide bearing 134. The proportional relationship between the turning of the wheel for steering and tilting it to give it a camber can be changed, for example by providing actuator arms with multiple holes over its length, as shown in FIG. 2A for star wheel 40, and changing the attachment points for the tie rod 140 and/or link 130.

Further, depending on whether actuator 138 rotates in the clockwise or counterclockwise direction, wheel 14 is turned to the right or the left by the desired degree, while both wheels 14 (only one is shown in FIG. 7A) are tilted to establish the desired camber proportionally to the degree by which the wheel is turned.

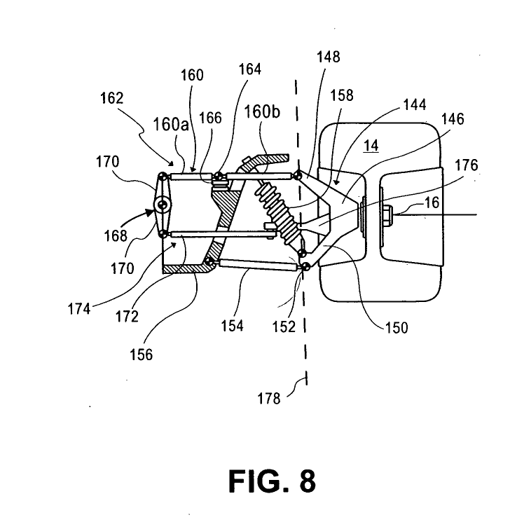

FIG. 8 shows another embodiment of the present invention applied to a wishbone suspension 144 for steering wheel 14. It has a steering knuckle 146 from which spindle 16 for wheel 14 extends and includes upwardly and downwardly extending legs 148, 150. The lower leg 150 is pivotally connected at 152 to an outboard end of a lower arm 154, the inboard end of which is pivotally connected to a chassis 156, as is well known to those skilled in the art. A strut assembly including a shock absorber and a helical compression spring is conventionally attached to the lower leg 150 of the wishbone connection and an upper wing portion of chassis 156.

The upper leg 148 of knuckle 146 is pivotally connected to a link 160 of a camber adjustment system 162. The link defines an assembly made up of first and second link sections 160a, 160b which are interconnected by a pivot connection 164 that is supported by a linear slide assembly 166. In a preferred embodiment of the invention, the outer link section 160b is formed by an arm of the upper wishbone.

The inboard end of link section 160a is pivotally attached to a pivotable actuator 168 which has arms 170 extending in opposite directions.

When actuator 168 is pivoted about its axis, it pushes or pulls link 160, depending on the direction of rotation, thereby pivoting knuckle 146 about camber pivot 152, which tilts wheel 14 relative to the vertical and imparts a camber to the wheel.

A tie rod 172 of a steering mechanism 174 has its inboard end pivotally attached to the other arm 170 of actuator 168. The outboard end of the tie rod is pivotally attached to a tie rod arm 176 of knuckle 146 so that, upon pivoting of actuator 168, the tie rod is pushed outwardly or pulled inwardly and the wheel is turned or steered accordingly about a vertical steering axis 178.

In operation, when turning is desired, the steering system of the vehicle will pivotally move actuator 168 in one direction or the other. This results in an outward push on camber adjustment link 160 and an inward pull of steering tie rod 172 in proportional amounts. The outward push (or inward pull when the actuator is turned in the other direction) of link 160 causes knuckle 146, and therewith wheel 14, to be tilted about camber pivot 152 relative to the vertical to establish the desired wheel camber in the desired direction. Thus, the more wheel 14 is turned, the greater is the camber that is imparted to the wheel, and vice versa.

FIG. 8 only shows one steered wheel. The combined steering mechanism and camber adjustment system are applied equally to the other steered wheel (not shown in FIG. 8).

Moreover, the combined steering and tilting mechanism of the present invention can also be adapted to cause camber in the non-steered, e.g. rear, wheels (not shown in FIGS. 7A and 8) should that be desirable.

In many production cars, the steering mechanism, and in particular the tie rod which connects to the knuckle for steering the wheel about a vertical steering axis, is located behind the wheel in the driving direction of the car. The embodiments of the invention described above are principally useful for such arrangements of the steering mechanism. However, when the steering mechanism, and in particular the steering tie rod, is located in front of the wheel, that is, in front of the wheel axle (spindle) and its suspension, the geometric configuration of the available space makes it difficult to mount the link for activating the camber system at the ends of opposite arms of the pivotal actuator or star wheel as described above. FIGS. 9A-9D show embodiments of the invention best suited for such applications.

Referring to FIGS. 9A-9D, in another embodiment of the present invention, the tie rod 180 of a steering mechanism 182 and the link 184 of a camber adjustment system 186 have their outboard ends coupled to knuckle 188 as described above. However, both the tie rod and the link are located forward of the wheel. In this configuration, the inboard ends of the tie rod and the link are attached to the same arm 190 of a pivoting actuator 192 due to space limitations. The steering mechanism tie rod is attached to arm 190 at a point radially further away from pivot axis 194 than the point where the inboard end of camber link 184 is attached to the arm. As a result, when the actuator 192 is pivoted, steering tie rod 180 and camber link 186 again move proportionally over different distances to steer the wheel and tilt it to establish a camber that is proportional to the extent to which the wheel is turned for steering. It should be pointed out that for ease of illustration the pivoting actuator 192 is shown in FIGS. 9A-9D as having a pivot axis 194 that is vertical so that the actuator pivots in a horizontal plane. This is optional and may be replaced by an actuator which pivots about a horizontal axis (as is shown in FIGS. 7A and 8, for example), depending on the available space and the configuration of other parts in the vicinity of the wheels, the steering mechanism and, when applicable, the engine of the car.

What is claimed is:

1. A camber adjustment apparatus for steered wheels of a vehicle comprising a wheel support structure for each steered wheel that rotatably mounts the wheel and is pivotable about a generally horizontal axis that is transverse to an axis of rotation of the wheel, a steering mechanism for pivotally moving the wheel about a steering axis for steering the wheels, and a camber adjusting mechanism for tilting the wheel support structure relative to a vertical plane as a function of and in response to pivotal movements of the support structure about the horizontal axis.

2. A camber adjustment apparatus according to claim 1 wherein the camber adjusting mechanism includes a link having a first end coupled to a pivotal member of the steering mechanism and a second end coupled to the support structure.

3. A camber adjustment apparatus according to claim 2 wherein the steering mechanism includes a pivotable actuator having a radially extending arm, and wherein the link is attached to the arm for moving the arm and therewith tilting the wheel support.

4. A camber adjustment apparatus according to claim 3 wherein the steering mechanism includes a tie rod having a first end attached to the arm and a second end attached to the wheel support for turning the wheel about the steering axis.

5. A camber adjustment apparatus according to claim 4 wherein the pivotable actuator comprises first and second oppositely oriented arms, and wherein the link is attached to the first arm and the tie rod is attached to the second arm.

6. A camber adjustment apparatus according to claim 5 wherein the tie rod and the link are arranged generally in front of an axis of the wheel.

7. A camber adjustment apparatus according to claim 3 wherein the steering mechanism includes a tie rod having one end attached to the same arm to which the link is attached and the other end attached to the wheel support structure, a radial spacing between a pivot axis of the actuator and an attachment point between the arm and the tie rod being greater than a radial spacing between the pivot axis of the actuator and an attachment point between the arm and the link.

8. A camber adjustment apparatus according to claim 7 wherein the tie rod and the link are arranged forward of an axis of the wheel.

9. A camber adjustment apparatus according to claim 2 including a bearing connected to the chassis which slidably guides the link.

10. A camber adjustment apparatus according to claim 9 wherein the bearing comprises first and second, generally horizontally arranged plates, one of the plates being coupled to the chassis and the other of the plates being coupled to the support structure, and a linear bearing disposed between the plates permitting the plates to linearly move relative to each other.

11. A camber adjustment apparatus according to claim 2 wherein the support structure comprises a McPherson suspension.

12. A camber adjustment apparatus according to claim 11 wherein the McPherson suspension includes a strut having a lower end proximate the axis of rotation and an upper end proximate the chassis, and wherein the second end of the link is coupled to the upper end of the strut.

13. A camber adjustment apparatus according to claim 12 including a linear bearing slidably supporting the link in a vicinity of the second end.

14. A camber adjustment apparatus according to claim 1 wherein the support structure comprises a wishbone suspension.

15. A camber adjustment apparatus according to claim 14 wherein the support structure has relatively upper and lower legs which extend from proximate the wheel towards the chassis, wherein the lower leg is pivotable about a generally horizontal axis that is transverse to the axis of rotation, and wherein the upper leg is operatively coupled to the camber adjusting mechanism so that activation of the steering mechanism causes the upper leg to move towards and away from the chassis.

16. A camber adjustment apparatus according to claim 15 including a link having a first end coupled to the steering mechanism and a second end coupled to the upper leg so that operation of the steering mechanism activates the camber adjusting mechanism and causes changes in the camber responsive to the steering of the vehicle.

17. A camber adjustment apparatus according to claim 16 including a linear slide for slidably supporting the link intermediate its ends.

18. A camber adjustment apparatus according to claim 17 wherein the link comprises first and second link sections, and a pivot connection between them, and wherein the slide supports the pivot connection.

19. A camber adjustment apparatus according to claim 17 wherein an end of the second link section comprises an elongated member of the wishbone suspension.

20. A combined vehicle steering and camber adjusting system having a McPherson suspension comprising:
a wheel to be steered;
a steering spindle for mounting the wheel to be steered for rotation about a generally vertical plane;
a steering knuckle attached to the steering spindle;
a strut assembly having an upper end attached to the vehicle chassis and a lower end supporting the steering knuckle;
a lower link pivoted at a first end to the steering knuckle and pivoted at a second end to the vehicle;
a steerage linkage assembly including the tie rod for a movement with the vehicle steering system and a tie rod arm for rotating the steering knuckle with the steering spindle about the strut assembly,
whereby movement of the tie rod by the vehicle steering system correspondingly moves the steering knuckle in rotation about the strut assembly to steer the vehicle,
a slide on the upper strut support for permitting movement of the strut assembly to change the camber of the strut assembly; and
a linkage between the vehicle steering system through the slide to change the camber of the strut assembly relative to the vehicle responsive to vehicle steering whereby the camber of a wheel is changed responsive to steering.

21. A combined vehicle steering and camber adjusting system having a double wishbone suspension comprising:
a wheel to be steered;
a steering spindle for mounting the wheel to be steered for rotation about a generally vertical plane;
a steering knuckle attached to the steering spindle;
an upper link attached to the upper end of the steering knuckle and to a point on the vehicle chassis; and
a lower link pivoted at a first end to the steering knuckle and pivoted at a second end on the vehicle chassis,
whereby the steering knuckle is pivotal about a steering axis including knuckle attachment to the upper strut at the upper portion and knuckle attachment to the lower strut and lower link at the lower portion;
a steerage linkage assembly including the tie rod for a movement with the steering system and a tie rod arm for rotating with the steering knuckle about the steering axis,
whereby movement of the tie rod by the vehicle steering system correspondingly moves the tie rod arm in rotation to steer the vehicle,
a strut assembly supported to the vehicle chassis at an upper end and pivoted to the steering knuckle at the lower end;
a chassis-supported slide on the upper linkage for permitting movement of the linkage to change the camber of the steering knuckle; and
a linkage between the vehicle steering system and upper linkage through the slide to change the camber of the steering axis relative to the vehicle responsive to vehicle steering whereby the camber of a wheel is changed responsive to steering.

22. A combined vehicle steering and camber adjusting system comprising:
a wheel to be steered;
a steering spindle for mounting the wheel to be steered for rotation about a generally vertical plane;
a steering knuckle;
a vertical kingpin through the steering knuckle for vertically pivoting the steering spindle relative to the steering knuckle to enable turning of the wheel to be steered;
an upper link pivoted at a first end to the steering knuckle and pivoted at a second end to the vehicle;
a lower link pivoted at a first end to the steering knuckle and pivoted at a second end to the vehicle;
a steerage linkage assembly including the tie rod for a movement with the vehicle steering system and a tie rod arm for rotating with the steering spindle about the vertical kingpin,
whereby movement of the tie rod by the vehicle steering system correspondingly moves the tie rod arm in rotation to steer the vehicle,
a linkage between the vehicle steering system and links to change the extension of at least one of the links relative to the vehicle whereby the camber of a wheel is changed responsive to movement of the steering system; and
the steering linkage assembly is in front of the vertical kingpin.
